(19) United States
(12) Patent Application Publication
(10) Pub. No.: US 2023/0287162 A1
(43) Pub. Date: Sep. 14, 2023

(54) THICKENING AGENT FOR A HYDRO-ALCOHOLIC COMPOSITION

(71) Applicant: COATEX, Genay (FR)

(72) Inventors: Yves KENSICHER, Theize (FR); Benoit MAGNY, Fontaines Saint Martin (FR); Laurie PARRENIN, Villeneuve (FR); Jean Marc SUAU, Lucenay (FR)

(73) Assignee: COATEX, Genay (FR)

(21) Appl. No.: 18/005,893

(22) PCT Filed: Jul. 29, 2021
(86) PCT No.: PCT/FR2021/000087

§ 371 Date: Jan. 18, 2023

(30) Foreign Application Priority Data
Aug. 3, 2020 (FR) FR2008245

(51) Int. Cl. C08F 220/58

(52) U.S. Cl. CPC C08F 220/58

(57) ABSTRACT

The invention relates to a thickening agent P for an aqueous composition, in particular for a hydro-alcoholic composition. The thickening agent P is prepared in the absence of acrylamide by a polymerisation reaction using N-methylol acrylamide or one of the derivatives thereof, an acid and an acid ester. A specific condensate of (meth)acrylic acid and N-methylol acrylamide are part of the invention. The invention also provides a hydro-alcoholic composition, the viscosity of the hydro-alcoholic composition being controlled.

The invention also provides a hydro-alcoholic composition, the viscosity of the hydro-alcoholic composition being controlled.

The invention relates to a thickening agent P for aqueous compositions, particularly for hydroalcoholic compositions. The thickening agent P is prepared in the absence of acrylamide by a polymerisation reaction using N-methylol-acrylamide or a derivative thereof, an acid and an acid ester. A particular condensate of (meth)acrylic acid and N-methylol-acrylamide is part of the invention. The invention also provides a hydroalcoholic composition with controlled viscosity.

When using an aqueous composition, the appearance and form of this composition are essential properties. In particular, to facilitate its use but also to improve its efficacy, an aqueous composition must have a controlled viscosity. In particular, a hydroalcoholic composition must have a viscosity that is suitable for its use.

When using a hydroalcoholic composition, it is important to avoid spatters or loss of composition. It is also important to be able to apply it easily, with no loss or difficulty.

In addition, the compatibility between the various ingredients of a hydroalcoholic composition is also a very important property. It is particularly important for a hydroalcoholic composition to comprise a high proportion of at least one alcohol, in particular a high proportion of ethanol or of isopropanol.

Controlling viscosity when preparing stable hydroalcoholic compositions is usually difficult for several reasons. Indeed, the addition of alcohol in an aqueous composition tends to substantially reduce the surface tension, then making it difficult to maintain its viscosity. Moreover, the addition of alcohol to such an aqueous composition may increase the solubility of other ingredients and thus destabilise the hydroalcoholic composition. Thickening agents for aqueous compositions, particularly hydroalcoholic compositions, are not always sufficiently effective against the various problems encountered. Document WO 2006016035 discloses hydroalcoholic compositions comprising a hydrophobic thickening compound. Document JP 2019003926 discloses thickening compounds for electrode preparation suspensions. Document JP S4828555 discloses unsaturated compounds. Document GB 1356030 discloses binder compounds for coating paper. Document DE 2531235 discloses thickening compounds for paint or for printing pulp.

Moreover, there are known thickening agents that are prepared from acrylamide (H₂C═C(═O)OCH₂NH₂). As this compound may be considered problematic or even to be avoided, it is important to be able to have thickening agents prepared in the absence of acrylamide.

The form of a thickening agent for aqueous compositions, particularly for hydroalcoholic compositions, is also important. It is therefore particularly advantageous to have such an agent in the form of an aqueous dispersion or of a solid that can be easily incorporated into such a composition. Using a thickening agent in powder form can in particular avoid the use of an organic solvent other than an alcohol. Avoiding any organic solvent other than an alcohol in an aqueous composition, particularly in a hydroalcoholic composition, then makes it possible to limit or eliminate the problems relating to these solvents, in particular the problems relating to their handling or the regulatory or health problems relating to their presence.

Preparing a hydroalcoholic composition can also cause problems. For example, thorough and uniform incorporation of the various ingredients is essential. Stability, including viscosity retention, is also an important property of thickened aqueous compositions, particularly for thickened hydroalcoholic compositions.

The invention makes it possible to provide a solution to all or part of the problems of the thickening agents for aqueous compositions of the prior art, in particular thickening agents for hydroalcoholic compositions.

Thus, the invention provides a thickening agent P prepared, in the absence of acrylamide, by at least one polymerisation reaction:
a. of from more than 30% by weight to 69.75% by weight of at least one anionic monomer (a) chosen among acrylic acid, an acrylic acid salt, methacrylic acid, a methacrylic acid salt and combinations thereof;
b. of from 29.75% by weight to less than 65% by weight of at least one non-ionic monomer (b) chosen among the C₁-C₈ esters of an acid chosen among acrylic acid, methacrylic acid and combinations thereof;
c. of from 0.5 to 5% by weight of at least one compound (c) of formula I:

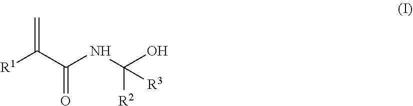

wherein:
R¹ independently represents H or CH₃,
R² and R³, identical or different, independently represent H, CH₃ or CH₂CH₃, relative to the total amount by weight of monomers (a), (b) and (c).

Also preferably according to the invention, compound (b) is chosen among methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate, vinyl acetate and combinations thereof. More preferably according to the invention, compound (b) is chosen among ethyl acrylate, butyl acrylate, methyl methacrylate, and combinations thereof.

Also preferably according to the invention, compound (c) is a compound of formula I wherein R² and R³ represent H. More preferably according to the invention, compound (c) is chosen among N-methylol-acrylamide, N-methylol-methacrylamide, more preferentially N-methylol-acrylamide.

Also preferably according to the invention, the agent P is fully or partially neutralised, preferably by means of at least one compound chosen among NaOH, KOH, ammonium derivatives, ammonia, amine bases, for example triethanolamine or 2-amino-2-methyl-propanol (AMP) and combinations thereof. More preferably, the agent P is neutralised by means of at least one compound chosen among the amino bases, for example triethanolamine or 2-amino-2-methyl-propanol (AMP).

Advantageously according to the invention, the agent P can also be fully or partially coacervated. Preferably, the agent P is fully or partially coacervated by reducing the pH, for example by reducing the pH to a value of less than 6.5, in particular by means of an acid compound, in particular by means of least one organic or inorganic acid compound, in particular an acid compound chosen among phosphoric acid, citric acid, glucono-lactone, lactic acid, salicylic acid, glycolic acid, ascorbic acid, glutamic acid, hydrochloric acid, acetic acid, D-gluconic acid, sulphonic acid, methanesulphonic acid, benzimidazole sulphonic acid, tartaric acid, 4-aminobenzoic acid, benzoic acid, sorbic acid, phenylbenzimidazole sulphonic acid, benzylidene camphor sulphonic acid, terephthalylidene dicamphor sulphonic acid, kojic acid, hyaluronic acid. Also preferably, the agent P is fully or partially coacervated by increasing the ionic strength, for example by adding at least one ionised compound or at least one salt, in particular NaCl, KCl, MgCl₂, CaCl₂, MgSO₄, CaSO₄, or by adding phenylbenzimidazole sulphonic acid (PBSA) or pyroglutamic acid sodium salt (NaPCA) or even by adding at least one ionised organic sun filter.

Preferably according to the invention, the polymerisation reaction uses:
from 32.5 to 64.75% by weight, of monomer (a),
from 34.75 to 62.5% by weight of monomer (b) and
from 0.5 to 5% by weight of monomer (c), relative to the total amount by weight of monomers (a), (b) and (c).

The agent P according to the invention is prepared from the essential compounds (a), (b) and (c) in the absence of acrylamide. Compounds (a), (b) and (c) may be used alone or combined with one or more other compounds or monomers. Particularly advantageously, the invention provides an agent Pa according to the invention that is prepared only from compounds (a), (b) and (c).

Also advantageously, the agent P according to the invention is prepared from a polymerisation reaction that also uses at least one particular additional compound.

According to the invention, a particular additional compound is a non-ionic monomer (d) chosen among the C₁-C₈ esters of an acid chosen among itaconic acid and maleic acid, preferably a monomer (d) chosen among methyl itaconate, ethyl itaconate, propyl itaconate, butyl itaconate, methyl maleate, ethyl maleate, propyl maleate, butyl maleate and combinations thereof. Preferably according to the invention, monomer (d) can be used in an amount ranging from 5 to 30% by weight of the amount of non-ionic monomer (b) used.

According to the invention, another particular additional compound is a compound (e) of formula II:

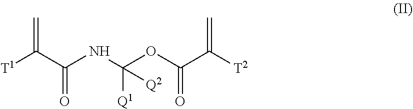

wherein:
T¹ and T², identical or different, independently represent H or CH₃,
Q¹ and Q², identical or different, independently represent H, CH₃ or CH₂CH₃.

Preferably according to the invention, compound (e) is prepared by a prior reaction or by an in situ reaction between at least one compound (a) and at least one compound (c) of formula (I) defined according to the invention. Advantageously, the polymerisation reaction can use less than 8% by weight, preferably from 0.2 to 8% by weight, in particular from 0.5 to 5% by weight, of monomer (e) relative to the total amount by weight of monomers.

According to the invention, another particular additional compound is a compound (f) chosen among 2-acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacrylate phosphate, their salts and combinations thereof. 2-acrylamido-2-methylpropane sulphonic acid is the preferred compound (f). Advantageously, the polymerisation reaction can use less than 20% by weight, preferably from 0.2 to 20% by weight, in particular from 0.5 to 10% by weight, of monomer (f) relative to the total amount by weight of monomers.

According to the invention, another particular additional compound is a compound (g) chosen among hydroxyethyl acrylate, hydroxypropyl acrylate, hydroxyethylhexyl acrylate, hydroxyethyl methacrylate, hydroxypropyl methacrylate, hydroxyethylhexyl methacrylate. Advantageously, the polymerisation reaction can use less than 20% by weight, preferably from 0.2 to 20% by weight, in particular from 0.5 to 10% by weight, of monomer (g) relative to the total amount by weight of monomers.

According to the invention, another particular additional compound is a cross-linking monomer (h) or at least one monomer comprising at least two olefinic unsaturations. Advantageously, the polymerisation reaction can use less than 5% by weight, preferably from 0.01 to 4% by weight, particularly from 0.02 to 4% by weight or from 0.02 to 2% by weight, in particular from 0.02 to 1% by weight, of monomer (h) relative to the total amount by weight of monomers.

According to the invention, another particular additional compound is an associative monomer (i), preferably a compound (i) of formula III:

G¹-(OE)ₘ-(OP)ₙ-G² (III)

wherein:
m and n, identical or different, independently represent 0 or an integer or decimal less than 150, m or n being different from 0,
EO independently represents a CH₂CH₂O group,
PO independently represents a group chosen among CH(CH₃)CH₂O and CH₂CH(CH₃)O,
G¹ represents a group comprising at least one polymerisable olefinic unsaturation, preferably an acrylate group or a methacrylate group and
G² represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group or a group comprising 2 to 5 phenyls or a tristyrylphenyl group or a pentastyrylcumylphenyl group.

Advantageously, the polymerisation reaction can use less than 20% by weight, preferably from 0.05 to 20% by weight, in particular from 0.1 to 10% by weight, of monomer (i) relative to the total amount by weight of monomers.

Advantageously, the invention provides an agent Pb prepared from compounds (a), (b) and (c) and from at least one compound (f), preferably 2-acrylamido-2-methylpropane sulphonic acid. Also advantageously, the invention provides an agent Pc prepared from compounds (a), (b) and (c) and from at least one compound (i). Advantageously, the invention provides an agent Pd prepared from compounds (a), (b) and (c), at from least one compound (f), preferably 2-acrylamido-2-methylpropane sulphonic acid, and from at least one compound (i). Also advantageously, the invention provides an agent Pe prepared from compounds (a), (b) and (c) and from at least one compound (h). Also advantageously, the invention provides an agent Pf prepared from compounds (a), (b) and (c) and from at least one compound (e).

Preferably, the agent P according to the invention has a glass transition temperature greater than −10° C. or greater than 0° C. Preferably, the glass transition temperature of the agent P is greater than 15° C. or greater than 25° C. Also preferably, the agent P according to the invention is a solid, more preferentially a powder.

The preparation of the agent P according to the invention may include the use of a compound (e) of formula II. The invention also provides a compound (e) of formula II:

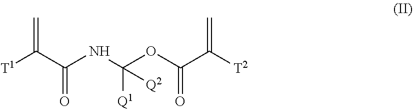

wherein:
T¹ and T², identical or different, independently represent H or CH₃,
Q¹ and Q², identical or different, independently represent H, CH₃ or CH₂CH₃. Preferably according to the invention, compound (e) according to the invention is a compound of formula II wherein Q¹ and Q² represent H. The particularly preferred compound (e) according to the invention is chosen among:
a compound (e1) of formula II wherein T¹, T², Q¹ and Q² represent H,
a compound (e2) of formula II wherein T¹ represents CH₃, T², Q¹ and Q² represent H,
a compound (e3) of formula II wherein T² represents CH₃, T¹, Q¹ and Q² represents H,
a compound (e4) of formula II wherein T¹ and T², represent CH₃, Q¹ and Q² represent H.

Compound (e3) is more particularly preferred according to the invention.

Compound (e) according to the invention can be prepared by a condensation reaction of at least one compound (a) according to the invention with at least one compound (c) according to the invention.

In addition, the invention also provides a method for preparing a copolymer, in particular a (H)ASE [(Hydrophobized) Alkali-Swellable Emulsion copolymer or an alkali-inflatable polymeric emulsion capable of being treated hydrophobically], by polymerisation reaction of a compound (e) according to the invention with at least one polymerisable compound, in particular with at least one polymerisable compound chosen among a compound (a) according to the invention, a compound (b) according to the invention and combinations thereof. This polymerisation reaction may also use at least one other additional compound chosen among a compound (c) according to the invention, a compound (d) according to the invention, a compound (f) according to the invention, a compound (g) according to the invention, a compound (h) according to the invention, a compound (i) according to the invention and combinations thereof.

The agent P according to the invention is a particularly effective thickening agent, in particular for controlling the viscosity of an aqueous composition. Thus, the invention provides a method for controlling the viscosity of an aqueous composition comprising adding at least one agent P according to the invention to an aqueous composition. The resulting thickened aqueous composition is also part of the invention. The invention therefore also provides an aqueous composition C comprising water and at least one agent P according to the invention. Preferably according to the invention, composition C according to the invention is chosen among a detergent composition, a sanitary composition, a disinfectant composition, a cosmetic composition, a coating composition, a paper coating colour composition, a textile printing composition, a textile coating composition. The preferred sanitary or disinfectant compositions according to the invention are chosen among an antibacterial composition, a bactericidal composition, a biocide composition, a bacteriostatic composition, an antiviral composition.

Preferably according to the invention, composition C also comprises at least one additive chosen among an alcohol, an oxidising compound, an emollient compound, a surfactant compound and combinations thereof. More preferably according to the invention, composition C also comprises at least one alcohol and optionally at least one additive chosen among an oxidising compound, an emollient compound, a surfactant compound and combinations thereof. Preferably according to the invention, the alcohol used is chosen among ethanol, n-propanol, isopropanol and combinations thereof.

A composition C according to the more preferred invention comprises:
from 0.1 to 5% by weight of at least one agent P,
from 45 to 9.9% by weight of water,
from 50 à 90% by weight of at least one alcohol.

The agent P according to the invention makes it possible to effectively control the viscosity of an aqueous composition. Thus, the invention provides a composition C according to the invention which has a Brookfield viscosity, measured at 25° C. and at 6 rpm, comprised between 800 and 20,000 mPa·s, preferably comprised between 1,000 and 15,000 mPa·s or comprised between 5,000 and 15,000 mPa·s.

Advantageously, the composition according to the invention is in the form of a gel or in the form of a foam.

Composition C according to the invention can be used in various media, in particular in an acidic medium or in a basic medium. Preferably, composition C according to the invention has a pH greater than 6 or greater than 6.5. Also preferably, composition C according to the invention has a pH of less than 13, preferably less than 12, more preferentially less than 11. More preferentially, composition C according to the invention has a pH ranging from 6 to 13 or from 6 to 12 or from 6 to 11, also more preferentially ranging from 6.5 to 13 or from 6.5 to 12 or from 6.5 to 11.

The invention also provides a method for preparing a hydroalcoholic solution comprising mixing, in water, at least one agent P according to the invention and at least one alcohol and optionally at least one additive chosen among an oxidising compound, an emollient compound, a surfactant compound and combinations thereof.

The particular, advantageous or preferred characteristics of the agent P according to the invention make it possible to define compositions according to the invention as well as various methods according to the invention which are also particular, advantageous or preferred.

The following examples illustrate the various aspects of the invention. Unless otherwise specified, the reagents used are acrylic acid (AA), methacrylic acid (MAA), ethyl acrylate (EA), butyl acrylate (BuA), N-methylol-acrylamide (NMA), 2-acrylamido-2-methylpropane sulphonic acid (AMPS in the form of a 50% aqueous solution of sodium salt).

### Example 1: Preparation and Characterisation of Agents P According to the Invention

### Preparation and Characterisation of Copolymer (P1) According to the Invention

In the reactor, place an initial load comprised of 460 g of deionised water and 2.3 g of sodium dodecyl sulphate.

In a first glass beaker and according to the proportions listed in Table 1, weigh 121.37 g of monomer (a), 196.55 g of monomer (b), 5.67 g of monomer (c) of formula I wherein R¹, R² and R³ represent H, 1.92 g of sodium dodecyl sulphate and 145 g of deionised water.

In a second glass beaker, weigh 0.270 g of ammonium persulphate and then dissolve it in 45 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (P1) is obtained at 30.5% by weight of solids content, the composition of which is broken down in Table 1.

### Preparation and Characterisation of Copolymer (P2) According to the Invention

In the reactor, place an initial load comprised of 445 g of deionised water and 2.3 g of sodium dodecyl sulphate.

In a first glass beaker and according to the proportions listed in Table 1, weigh 108.95 g of monomer (a), 184.12 g of monomer (b), 24.85 g of another monomer (b), 5.67 g of monomer (c) of formula I wherein R¹, R² and R³ represent H, 1.92 g of sodium dodecyl sulphate and 140 g of deionised water.

In a second glass beaker, weigh 0.270 g of ammonium persulphate and then dissolve it in 45 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (P2) is obtained at 30.5% by weight of solids content, the composition of which is broken down in Table 1.

### Preparation and Characterisation of Copolymer (P3) According to the Invention

In the reactor, place an initial load comprised of 460 g of deionised water and 2.3 g of sodium dodecyl sulphate.

In a first glass beaker and according to the proportions listed in Table 1, weigh 110.76 g of monomer (a), 185.95 g of monomer (b), 16.18 g of another monomer (b), 5.67 g of monomer (c) of formula I wherein R¹, R² and R³ represent H, 1.92 g of sodium dodecyl sulphate and 145 g of deionised water.

In a second glass beaker, weigh 0.270 g of ammonium persulphate and then dissolve it in 45 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (P3) is obtained at 30.2% by weight of solids content, the composition of which is broken down in Table 1.

### Preparation and Characterisation of Copolymer (P4) According to the Invention

In the reactor, place an initial load comprised of 450 g of deionised water and 2.97 g of sodium dodecyl sulphate.

In a first glass beaker and according to the proportions listed in Table 1, weigh 126.77 g of monomer (a), 158.25 g of monomer (b), 4.46 g of monomer (c) of formula I wherein R¹, R² and R³ represent H, 7.90 g of monomer (i) compound of formula III wherein G¹ represents a methacrylate group, G² represents a straight C₂₂-alkyl group, m represents 25 and n represents 0 (C22-EO25 methacrylate), 1.76 g of sodium dodecyl sulphate and 130 g of deionised water.

Heat the reactor content to 86° C.±2° C.

In a second glass beaker, weigh 0.194 g of ammonium persulphate and then dissolve it in 40 g of deionised water.

Inject the reagents from the 2 beakers into the polymerisation reactor in 2 hours at a temperature of 86° C.±2° C.

Then, inject 0.106 g of ammonium persulphate dissolved in 20 g of deionised water into the reactor in 1 hour.

Then, bake for 30 minutes before allowing the medium to cool and then filtering it.

A copolymer (P4) is obtained at 30.4% by weight of solids content, the composition of which is broken down in Table 1.

### Preparation and Characterisation of Copolymer (P5) According to the Invention

In the reactor, place an initial load comprised of 445 g of deionised water and 2.3 g of sodium dodecyl sulphate.

In a first glass beaker and according to the proportions listed in Table 1, weigh 106.43 g of monomer (a), 181.61 g of monomer (b), 24.85 g of another monomer (b), 5.67 g of monomer (c), 1.92 g of sodium dodecyl sulphate and 140 g of deionised water and 5.03 g of triallyl cyanurate.

In a second glass beaker, weigh 0.270 g of ammonium persulphate and then dissolve it in 50 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (P5) is obtained at 30.7% by weight of solids content, the composition of which is broken down in Table 1.

### Preparation and Characterisation of Copolymer (P6) According to the Invention

In the reactor, place an initial load comprised of 465 g of deionised water and 6.47 g of sodium dodecyl sulphate.

In a first glass container and according to the proportions listed in Table 1, weigh 108.14 g of monomer (a), 184.11 g of monomer (b), 2.89 g of monomer (c) of formula I wherein R¹, R² and R³ represent H, 2.82 g of sodium dodecyl sulphate and 124.4 g of deionised water.

In a second glass container, weigh 0.914 g of ammonium persulphate and then dissolve it in 10 g of deionised water.

In a third glass container, weigh 0.099 g of sodium metabisulphite and then dissolve it in 10 g of deionised water.

In a fourth container, such as a disposable syringe, weigh 5.31 g of monomer (f) 2-acrylamido-2-methylpropane sulphonic acid sodium salt at 50% by weight in water.

Heat the reactor content to 76° C.±2° C.

Inject the reagents from the 4 containers into the polymerisation reactor in 2 hours at a temperature of 86° C.±2° C.

Then, inject 0.3 g of ammonium persulphate dissolved in 20 g of deionised water into the reactor in 1 hour.

Then, bake for 1 hour before allowing the medium to cool and then filtering it.

A copolymer (P6) is obtained at 30.2% by weight of solids content, the composition of which is broken down in Table 1.

### Preparation and Characterisation of Copolymer (P7) According to the Invention

In the reactor, place an initial load comprised of 474.69 g of deionised water and 2.96 g of sodium dodecyl sulphate.

In a first glass beaker and according to the proportions listed in Table 1, weigh 148.29 g of monomer (a), 159.95 g of monomer (b), 2.44 g of monomer (c) of formula I wherein R¹, R² and R³ represent H, 7.89 g of monomer (i) compound of formula III wherein G¹ represents a methacrylate group, G² represents a straight C22-alkyl group, m represents 25 and n represents 0 (C22-EO25 methacrylate), 1.76 g of sodium dodecyl sulphate and 151.62 g of deionised water.

Heat the reactor content to 86° C.±2° C.

In a second glass beaker, weigh 0.194 g of ammonium persulphate and then dissolve it in 22 g of deionised water.

Inject the reagents from the 2 beakers into the polymerisation reactor in 2 hours at a temperature of 86° C.±2° C.

Then, inject 0.20 g of ammonium persulphate dissolved in 20 g of deionised water into the reactor in 1 hour.

Then, bake for 30 minutes before allowing the medium to cool and then filtering it.

A copolymer (P7) is obtained at 31.3% by weight of solids content of which the composition is broken down in Table 1.

TABLE 1

| | Monomère (quantité - % en poids) | | | | | |
|---|---|---|---|---|---|---|
| Agent | (a) | (b) | (c) | (f) | (h) | (i) |
| P1 | 37.51 (AMA) | 60.74 (AE) | 1.75 (NMA) | | | |
| P2 | 33.67 (AMA) | 56.90 (AE) | 1.75 (NMA) | | | |
| | | 7.68 (Abu) | | | | |
| P3 | 34.77 (AMA) | 58.37 (AE) | 1.78 (NMA) | | | |
| | | 5.08 (Abu) | | | | |
| P4 | 42.63 (AMA) | 53.22 (AD) | 1.50 (NMA) | | | 2.65 |
| P5 | 32.89 (AMA) | 56.12 (AE) | 1.75 (NMA) | | 1.55 | |
| | | 7.68 (Abu) | | | | |
| P6 | 36.31 (AA) | 61.82 (AE) | 0.97 (NMA) | 0.89 (AMPS) | | |
| P7 | 46.55 (AMA) | 50.21 (Abu) | 0.76 (NMA) | | | 2.48 |

### Example 2: Preparation and Characterisation of Comparative Copolymers

### Preparation and Characterisation of Comparative Copolymer (CP1)

The synthesis method is similar to the method for preparing agent P1. In a first glass container and according to the proportions listed in Table 2, weigh 112.98 g of monomer (a), 159.13 g of monomer (b), 0.695 g of monomer (h) diallyl phthalate, 1.92 g of sodium dodecyl sulphate and 140 g of deionised water.

In a second glass beaker, weigh 0.270 g of ammonium persulphate and then dissolve it in 50 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (CP1) is obtained at 30.1% by weight of solids content of which the composition is broken down in Table 2.

### Preparation and Characterisation of Comparative Copolymer (CP2)

The synthesis method is similar to the method for preparing agent P2. In a first glass beaker and according to the proportions listed in Table 2, weigh 123.65 g of monomer (a), 165.30 g of monomer (b), 11.50 g of monomer (i) compound of formula III wherein G¹ represents a methacrylate group, G² represents a straight C₂₂-alkyl group, m represents 25 and n represents 0 (C22-EO25 methacrylate), 1.92 g of sodium dodecyl sulphate and 140 g of deionised water.

In a second glass beaker, weigh 0.270 g of ammonium persulphate and then dissolve it in 50 g of deionised water.

Heat the reactor content to 86° C.±2° C.

Inject the reagents from the 2 beakers into the polymerisation reactor in 2 hours and 30 minutes at a temperature of 86° C.±2° C.

Then, inject 0.106 g of ammonium persulphate dissolved in 20 g of deionised water into the reactor in 1 hour.

Then, bake for 1 hour before allowing the medium to cool and then filtering it.

A copolymer (CP2) is obtained at 30.0% by weight of solids content of which the composition is broken down in Table 2.

TABLE 2

| | Monomère (quantité - % en poids) | | | | | | |
|---|---|---|---|---|---|---|---|
| Polymère | (a) | (b) | (c) | (e) | (f) | (h) | (i) |
| PC1 | 41.41 (AMA) | 58.33 (AE) | 0 | 0 | 0 | 0.25 | 0 |
| PC2 | 41.15 (AMA) | 55.02 (AE) | 0 | 0 | 0 | 0 | 3.83 |

### Example 3: Preparation and Characterisation of Hydroalcoholic Compositions According to the Invention and of Comparative Hydroalcoholic Compositions

From agents P1 to P5 and comparative copolymers CP1 and CP2, hydroalcoholic compositions C1 to C5 and CC1 and CC2 are prepared using the ingredients mixed in water in the amounts shown in Table 3.

TABLE 3

| | | | | |
|---|---|---|---|---|
| Phase A | Eau désionisée | Diluant | 23.15 | g |
| | Peroxyde d'hydrogène 3% | Biocide | 9.63 | g |
| | Glycérol 98% | Émollient | 4.21 | g |
| | Ethanol 96% | Désinfectant | 18.53 | g |
| Phase B | Agent P1 à P5 ou Copolymères | Épaississant | 12.00 | g |
| | PC1 et | | | |
| Phase C | Triethanolamine 50% | Neutralisant | 4.06 | g |
| Phase D | Ethanol 96% | Désinfectant | 128.42 | g |

| | | |
|---|---|---|
| Quantité totale | 200.00 | g |

In a 250 mL beaker equipped with a stirrer with a Rayneri blade of 40 mm in diameter, the ingredients from phase A are added until a homogeneous mixture is obtained.

While stirring, the thickening agent or copolymer of phase B is added, then the neutralising agent of phase C. The stirring speed is increased when the viscosity increases while keeping air from being incorporated. After adding all the neutralising agent, stirring is continued for 10 minutes.

The rest of the ethanol from phase D is then added and the stirring is continued for 10 minutes. Then, the composition is centrifuged to remove any air bubbles.

Then, the viscosity of hydroalcoholic compositions C1 to C5 and CC1 and CC2 is measured. The composition is placed in a thermostatically-controlled bath at 25° C. for 1 hour and the viscosity is measured using a Brookfield viscometer at 6 rpm. The results are shown in Table 4.

TABLE 4

| | Agent épaississant ou | Viscosité Brookfield |
|---|---|---|
| Composition | copolymère | (mPa · s) |
| C1 | P1 | 7 380 |
| C2 | P2 | 7 620 |
| C3 | P3 | 7 460 |
| C4 | P4 | 5 320 |
| C5 | P5 | 5 270 |
| CC1 | PC1 | 570 |
| CC2 | PC2 | 160 |

The agent P according to the invention makes it possible to prepare hydroalcoholic compositions with a high viscosity essential for the use of these compositions. This viscosity control is obtained with an agent P that is prepared in the absence of acrylamide.

The comparative copolymers do not make it possible to achieve an acceptable viscosity for hydroalcoholic compositions.

1. A thickening agent P prepared, in the absence of acrylamide, by at least one polymerisation reaction:
of from more than 30% by weight to 69.75% by weight of at least one anionic monomer (a) chosen among acrylic acid, an acrylic acid salt, methacrylic acid, a methacrylic acid salt and combinations thereof;
of from 29.75% by weight to less than 65% by weight of at least one non-ionic monomer (b) chosen among the C₁-C₈ esters of an acid chosen among acrylic acid, methacrylic acid and combinations thereof;
of from 0.5 to 5% by weight of at least one compound (c) of formula I: 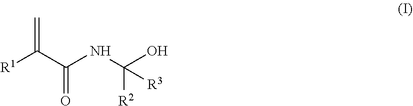
wherein:
R¹ independently represents H or CH₃,
R² and R³, identical or different, independently represent H, CH₃ or CH₂CH₃,
relative to the total amount by weight of monomers (a), (b) and (c).

2. The agent P according to claim 1 for which compound (b) is chosen among methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate, vinyl acetate and combinations thereof, more preferentially chosen among ethyl acrylate, butyl acrylate, methyl methacrylate and combination thereof.

3. The agent P according to one of claim 1, for which compound (c) is a compound of formula I wherein R² and R³ represent H, preferably compound (c) is chosen among N-methylol-acrylamide, N-methylol-methacrylamide, more preferentially N-methylol-acrylamide.

4. The agent P according to one of claim 1, which is fully or partially neutralised, preferably by means of at least one compound chosen among NaOH, KOH, ammonium derivatives, ammonia, amine bases, for example triethanolamine or 2-amino-2-methyl-propanol (AMP) and combinations thereof, preferably by means of at least one compound chosen among the amine bases, for example triethanolamine or 2-amino-2-methyl-propanol (AMP).

5. The agent P according to one of claim 1, which is fully or partially coacervated, preferably which is fully or partially coacervated:
by reducing the pH, for example by reducing the pH to a value of less than 6.5, in particular by means of an acid compound, in particular by means of least one organic or inorganic acid compound, in particular an acid compound chosen among phosphoric acid, citric acid, glucono-lactone, lactic acid, salicylic acid, glycolic acid, ascorbic acid, glutamic acid, hydrochloric acid, acetic acid, D-gluconic acid, sulphonic acid, methanesulphonic acid, benzimidazole sulphonic acid, tartaric acid, 4-aminobenzoic acid, benzoic acid, sorbic acid, phenylbenzimidazole sulphonic acid, benzylidene camphor sulphonic acid, terephthalylidene dicamphor sulphonic acid, kojic acid, hyaluronic acid or
by increasing the ionic strength, for example by adding at least one ionised compound or at least one salt, in particular NaCl, KCl, MgCl₂, CaCl₂, MgSO₄, CaSO₄, or by adding phenylbenzimidazole sulphonic acid (PBSA) or pyroglutamic acid sodium salt (NaPCA) or even by adding at least one ionised organic sun filter.

6. The agent P according to one of claim 1, for which the polymerisation reaction uses:
from 32.5 to 64.75% by weight of monomer (a),
from 34.75 to 62.5% by weight of monomer (b) and
from 0.5 to 5% by weight of monomer (c), relative to the total amount by weight of monomers (a), (b) and (c).

7. The agent P according to one of claim 1, for which the polymerisation reaction also uses at least one compound chosen among:
d. a non-ionic (d) monomer chosen among C₁-C₈ esters of an acid chosen among itaconic acid, maleic acid, preferably a monomer (d) chosen among methyl itaconate, ethyl itaconate, propyl itaconate, butyl itaconate, methyl maleate, ethyl maleate, propyl maleate, butyl maleate and combinations thereof or
e. a compound (e) of formula II: 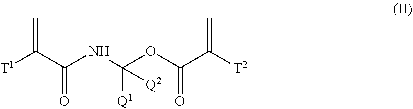
wherein:
T¹ and T², identical or different, independently represent H or CH₃,
Q¹ and Q², identical or different, independently represent H, CH₃ or CH₂CH₃,
preferably a compound (e) prepared by a prior reaction or by an in situ reaction between at least one compound (a) and at least one compound (c) of formula (I) defined according to one of the preceding claims, also preferably less than 8% by weight, preferably from 0.2 to 8% by weight, in particular from 0.5 to 5% by weight, of monomer (e) relative to the total amount by weight of monomers or
f. at least one compound (0 chosen among 2-acrylamido-2-methylpropane sulphonic acid, ethoxymethacrylate sulphonic acid, sodium methallyl sulphonate, styrene sulphonate, hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacrylate phosphate, their salts and combinations thereof, preferably less than 20% by weight, preferably from 0.2% to 20% by weight, in particular from 0.5% to 10% by weight, of monomer (0 relative to the total amount by weight of monomers or
g. at least one compound (g) chosen among hydroxyethyl acrylate, hydroxypropyl acrylate, hydroxyethylhexyl acrylate, hydroxyethyl methacrylate, hydroxypropyl methacrylate, hydroxyethylhexyl methacrylate, preferably less than 20% by weight, preferably from 0.2 to 20% by weight, in particular from 0.5 to 10% by weight, of monomer (g) relative to the total amount by weight of monomers or
h. a cross-linking monomer (h) or at least one monomer comprising at least two olefinic unsaturations, preferably less than 5% by weight, preferably from 0.01 to 4% by weight, in particular from 0.02 to 4% by weight or from 0.02 to 2% by weight, in particular from 0.02 to 1% by weight, of monomer (h) relative to the total amount by weight of monomers or
i. at least one associative monomer (i), preferably chosen among a compound of formula (III):
G¹-(OE)ₘ-(OP)ₙ-G² (III)
wherein:
m and n, identical or different, independently represent 0 or an integer or decimal less than 150, m or n being different from 0,
EO independently represents a CH₂CH₂O group,
PO independently represents a group chosen among CH(CH₃)CH₂O and CH₂CH(CH₃)O,
G¹ represents a group comprising at least one polymerisable olefinic unsaturation, preferably an acrylate group or a methacrylate group and
G² represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyls or a tristyrylphenyl group or a pentastyrylcumylphenyl group, preferably less than 20% by weight, preferably from 0.05 to 20% by weight, particularly from 0.1 to 10% by weight, of monomer (i) relative to the total quantity by weight of monomers.

8. The agent P according to one of claim 1, prepared from only compounds (a), (b) and (c).

9. The agent P according to one of claim 1 whose glass transition temperature is greater than −10° C. or greater than 0° C., preferably greater than 15° C. or greater than 25° C.

10. The agent P according to one of claim 1, which is a solid, preferably a powder.

11. The aqueous composition C comprising water and at least one agent P according to one of claim 1.

12. The composition C according to claim 11, chosen among a detergent composition, a sanitary composition, a disinfectant composition, a cosmetic composition, a coating composition, a paper coating colour composition, a textile printing composition, a textile coating composition.

13. The composition C according to one of claim 11 also comprising at least one additive chosen among an alcohol, an oxidising compound, an emollient compound, a surfactant compound and combinations thereof, preferably also comprising at least one alcohol and optionally at least one additive chosen among an oxidising compound, an emollient compound, a surfactant compound and combinations thereof, more preferentially a composition C comprising:
from 0.1 to 5% by weight of at least one agent P,
from 45 to 9.9% by weight of water,
from 50 à 90% by weight of at least one alcohol.

14. The composition C according to according to one of claim 11, which has a Brookfield viscosity, measured at 25° C. and at 6 rpm, comprised between 800 and 20,000 mPa·s, preferably comprised between 1,000 and 15,000 mPa·s or comprised between 5,000 and 15,000 mPa·s.

15. The composition C according to one of claim 11, that has:
a pH greater than 6 or greater than 6.5 or
a pH less than 13, preferably less than 12, more preferentially less than 11 or
a pH ranging from 6 to 13 or from 6 to 12 or from 6 to 11, also more preferentially ranging from 6.5 to 13 or from 6.5 to 12 or from 6.5 to 11.

16. A method for controlling the viscosity of an aqueous composition comprising the addition of at least one agent P according to one of claim 1 to an aqueous composition.

17. A method for preparing a hydroalcoholic solution comprising mixing, in water, at least one agent P according to one of claim 1 and at least one alcohol and optionally at least one additive chosen among an oxidising compound, an emollient compound, a surfactant compound and combinations thereof.

18. A compound of formula (II): 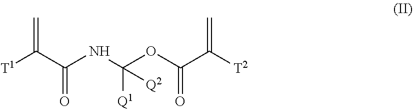
wherein:
T¹ and T², identical or different, independently represent H or CH₃,
Q¹ and Q², identical or different, independently represent H, CH₃ or CH₂CH₃.
